(19) United States
(12) Patent Application Publication
(10) Pub. No.: US 2025/0015607 A1
(43) Pub. Date: Jan. 9, 2025

(54) POWER SUPPLY DEVICE

(71) Applicant: Yazaki Corporation, Tokyo (JP)

(72) Inventors: Mitsuaki MORIMOTO, Susono-shi (JP); Kazuo SUGIMURA, Susono-shi (JP); Hiroteru KATO, Susono-shi (JP); Shoya WATANABE, Susono-shi (JP)

(73) Assignee: Yazaki Corporation, Tokyo (JP)

(21) Appl. No.: 18/891,435

(22) Filed: Sep. 20, 2024

Related U.S. Application Data
(63) Continuation of application No. PCT/JP2023/034234, filed on Sep. 21, 2023.

(30) Foreign Application Priority Data
Sep. 28, 2022 (JP) 2022-154504

(51) Int. Cl. H02J 7/00

(52) U.S. Cl. CPC H02J 7/0013

(57) ABSTRACT

It is provided a power supply device to connect a first anode-side battery terminal to a second cathode-side battery terminal, connect a first switch between a first cathode-side battery terminal and a cathode-side input terminal, connect a second switch between a first connection point, which is between the first anode-side battery terminal and the second cathode-side battery terminal, and the cathode-side input terminal, connect a third switch between a second connection point, which is between the first anode-side battery terminal and the second cathode-side battery terminal, and an anode-side input terminal, connect a fourth switch between a second anode-side battery terminal and an anode-side input terminal, connect the cathode-side output terminal to a line connecting the first switch and the first cathode-side battery terminal, and connect the anode-side output terminal to a line connecting the anode-side input terminal and the second anode-side battery terminal.

The present application is a continuation application of International Application No. PCT/JP2023/034234, filed on Sep. 21, 2023, whose priority is claimed on Japanese Patent Application No. 2022-154504, filed on Sep. 28, 2022. All of the contents of the International Application and the Japanese Patent Application are incorporated herein with reference.

### TECHNICAL FIELD

The present disclosure relates to a power supply device.

### BACKGROUND ART

The electric vehicles (EV) and the plug-in hybrid electric vehicles are becoming popular, and charging equipment that can charge the batteries of these electric vehicles is also becoming popular. There are various types in the standard of the currently installed charging equipment, and it is necessary for the power supply devices of the electric vehicles to be compatible with the charging equipment in the plurality of standards. For example, in Patent Document 1, a power supply device being compatible with a quick charger and an ultra-fast charger in which a voltage of supplied power is higher than that of the quick charger is provided by switching a connection of two batteries between a parallel connection and a connection in series.

### CITATION LIST

### Patent Documents

[Patent Document 1] JP 2020-150784A

### SUMMARY OF THE INVENTION

### Technical Problem

However, according to the power supply device disclosed in Patent Document 1, at the time of switching the connection of the two batteries, the voltage applied to a load changes significantly. Therefore, according to the power supply device disclosed in Patent Document 1, it is impossible to operate the load during the switching of the connection of the two batteries.

Accordingly, an object of the present invention is to provide a power supply device being compatible with various chargers without interrupting the operations of the load.

### Solution to Problem

In order to solve the above-identified technical problem, a power supply device according to an embodiment of the present invention includes a first cathode-side battery terminal and a first anode-side battery terminal for connecting a battery; a second cathode-side battery terminal and a second anode-side battery terminal for connecting a battery; a cathode-side input terminal and an anode-side input terminal for connecting a charger; a cathode-side output terminal and an anode-side output terminal for connecting a load; a first switch; a second switch; a third switch; and a fourth switch, wherein the first anode-side battery terminal is connected to the second cathode-side battery terminal, the first switch is connected between the first cathode-side battery terminal and the cathode-side input terminal, the second switch is connected between a first connection point, which is between the first anode-side battery terminal and the second cathode-side battery terminal, and the cathode-side input terminal, the third switch is connected between a second connection point, which is between the first anode-side battery terminal and the second cathode-side battery terminal, and the anode-side input terminal, the fourth switch is connected between the second anode-side battery terminal and the anode-side input terminal, the cathode-side output terminal is connected to a line connecting the first switch and the first cathode-side battery terminal, and the anode-side output terminal is connected to a line connecting the anode-side input terminal and the second anode-side battery terminal.

### Effect of the Invention

According to the present invention, it is possible to provide a power supply device being compatible with various chargers without interrupting the operations of the load.

### BRIEF DESCRIPTION OF THE DRAWINGS

FIG. 1 is a view showing a power supply device 100 according to an embodiment of the present invention.

FIG. 2 is a view for describing a power flow in the power supply device 100.

FIG. 3 is a view for describing a power flow in the power supply device 100.

FIG. 4 is a view for describing a power flow in the power supply device 100.

FIG. 5 is a view for describing a power flow in the power supply device 100.

FIG. 6 is a view for describing the charging of the first battery 210 and the second battery 220.

FIG. 7 is a view for describing the charging of the first battery 210 and the second battery 220.

### DESCRIPTION OF EMBODIMENTS

### <Power Supply Device 100>

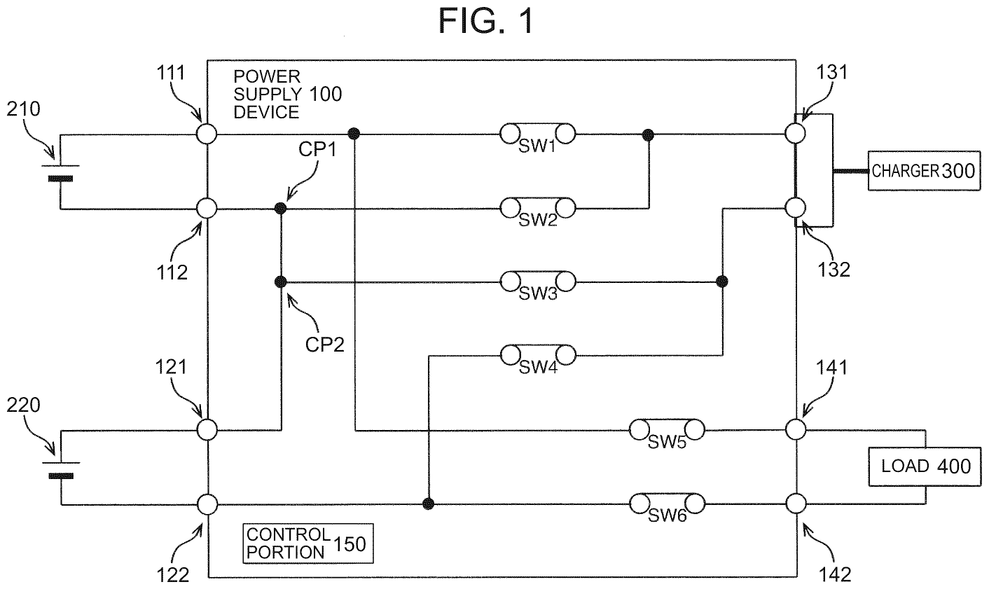

FIG. 1 is a view showing a power supply device 100 according to an embodiment of the present invention. The power supply device 100 includes a first cathode-side battery terminal 111, a first anode-side battery terminal 112, a second cathode-side battery terminal 121, a second anode-side battery terminal 122, a cathode-side input terminal 131, an anode-side input terminal 132, a first switch SW1, a second switch SW2, a third switch SW3, a fourth switch SW4, a cathode-side output terminal 141, and an anode-side output terminal 142.

The first cathode-side battery terminal 111 and the first anode-side battery terminal 112 are terminals for connecting the first battery 210, wherein the cathode of the first battery 210 is connected to the first cathode-side terminal 111, and the anode of the first battery 210 is connected to the first anode-side battery terminal 112. The second cathode-side battery terminal 121 and the second anode-side battery terminal 122 are terminals for connecting the second battery 220, wherein the cathode of the second battery 220 is connected to the second cathode-side battery terminal 121, and the anode of the second battery 220 is connected to the second anode-side battery terminal 122. The first battery 210 and the second battery 220 are storage batteries, for example, the lithium ion batteries that are capable of charging and discharging the electricity. The drive voltages of the first battery 210 and the second battery 220 are the same with each other as a first voltage (for example, 400V).

According to the present embodiment, the first anode-side battery terminal 112 is connected to the second cathode-side battery terminal 121. Therefore, according to the present embodiment, the first battery 210 and the second battery 220 are connected in series.

The cathode-side input terminal 131 and the anode-side input terminal 132 are terminals for connecting the charger 300. When a first charger 300A (for example, a quick charger) that supplies the electricity with a second voltage (for example, 400V and 500V) being equal to or higher than the first voltage and lower than twice the first voltage is connected to the cathode-side input terminal 131 and the anode-side input terminal 132, the electricity of the second voltage is input from the cathode-side input terminal 131 and the anode-side input terminal 132. When a second charger 300B (for example, an ultra-fast charger) that supplies the electricity with a third voltage (for example, 800V and 1000V) being equal to or higher than twice the first voltage is connected to the cathode-side input terminal 131 and the anode-side input terminal 132, the electricity of the third voltage is input from the cathode-side input terminal 131 and the anode-side input terminal 132.

According to the present embodiment, the first switch SW1 is connected between the first cathode-side battery terminal 111 and the cathode-side input terminal 131. The second switch SW2 is connected between a first connection point CP1, which is between the first anode-side battery terminal 112 and the second cathode-side battery terminal 121, and the cathode-side input terminal 131. The third switch SW3 is connected between a second connection point CP2, which is between the first anode-side battery terminal 112 and the second cathode-side battery terminal 121, and the anode-side input terminal 132. The fourth switch SW4 is connected between the second anode-side battery terminal 122 and the anode-side input terminal 132.

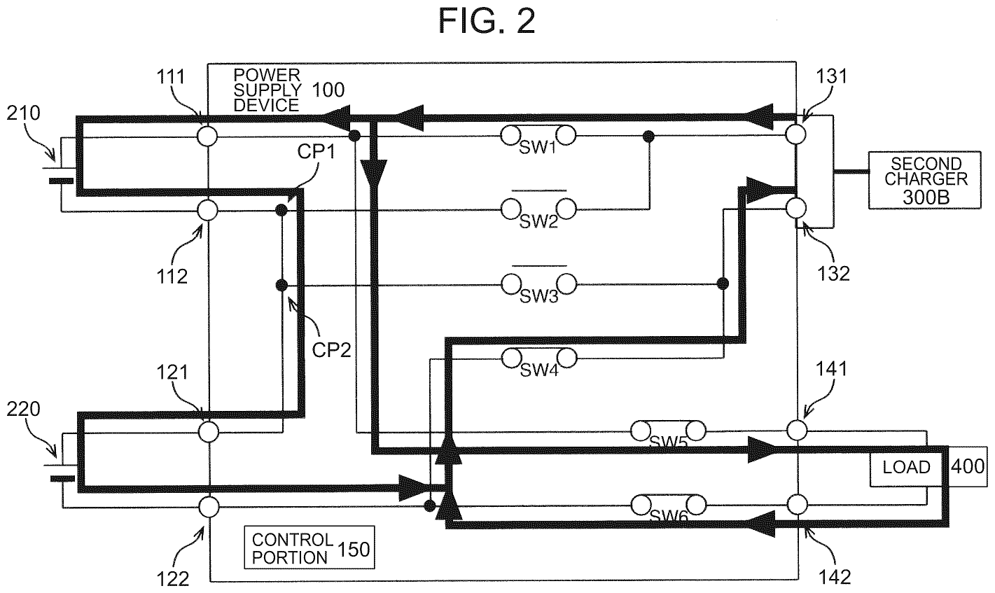

Accordingly, according to the present embodiment, in a state in which the first switch SW1 and the fourth switch SW4 are closed while the second switch SW2 and the third switch SW3 are open, as shown in FIG. 2, the first battery 210 and the second battery 220 are connected in series between the cathode-side input terminal 131 and the anode-side input terminal 132. Accordingly, as shown in FIG. 2, in a state in which the first switch SW1 and the fourth switch SW4 are closed while the second switch SW2 and the third switch SW3 are open, in a case of connecting the charger to the cathode-side input terminal 131 and the anode-side input terminal 132, it is possible to charge the first battery 210 and the second battery 220 that are connected in series.

Then, according to the present embodiment, when the second charger 300B (for example, the ultra-fast charger) is connected to the cathode-side input terminal 131 and the anode-side input terminal 132, the first switch SW1 and the fourth switch SW4 are closed while the second switch SW2 and the third switch SW3 are open to charge the first battery 210 and the second battery 220 in the state of being connected in series. In this manner, according to the present embodiment, it is possible to charge each of the first battery 210 and the second battery 220 by the electricity at the voltage being equal to or lower than half of the third voltage, that is, by the electricity of the voltage corresponding to the first voltage as the drive voltage of the first battery 210 and the second battery 220.

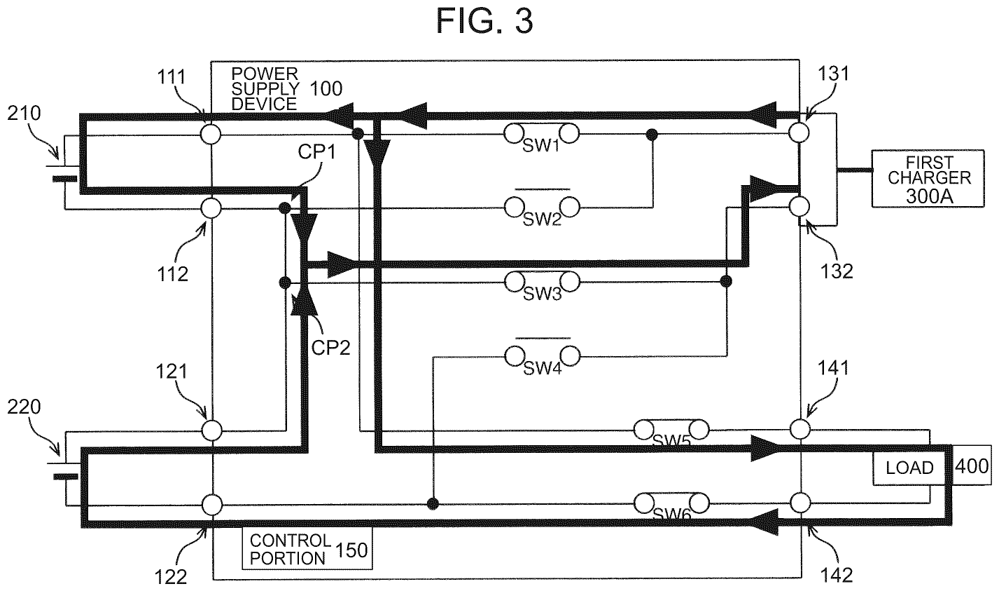

Also, according to the present embodiment, in a state (first state) in which the first switch SW1 and the third switch SW3 are closed while the second switch SW2 and the fourth switch SW4 are open, as shown in FIG. 3, the cathode of the first battery 210 is connected to the cathode-side input terminal 131, and the anode of the first battery 210 is connected to the anode-side input terminal 132. Therefore, as shown in FIG. 3, in this first state, in a case of connecting the charger 300 to the cathode-side input terminal 131 and the anode-side input terminal 132, it becomes possible to charge the first battery 210 by this charger 300.

Then, according to the present embodiment, when the first charger 300A (for example, the quick charger) is connected to the cathode-side input terminal 131 and the anode-side input terminal 132, the first switch SW1 and the third switch SW3 are closed while the second switch SW2 and the fourth switch SW4 are open such that the first switch SW1 to the fourth switch SW4 are put into the first state to charge the first battery 210. In this manner, according to the present embodiment, it is possible to charge the first battery 210 by the electricity at the second voltage, that is, by the electricity at the voltage corresponding to the first voltage as the drive voltage of the first battery 210.

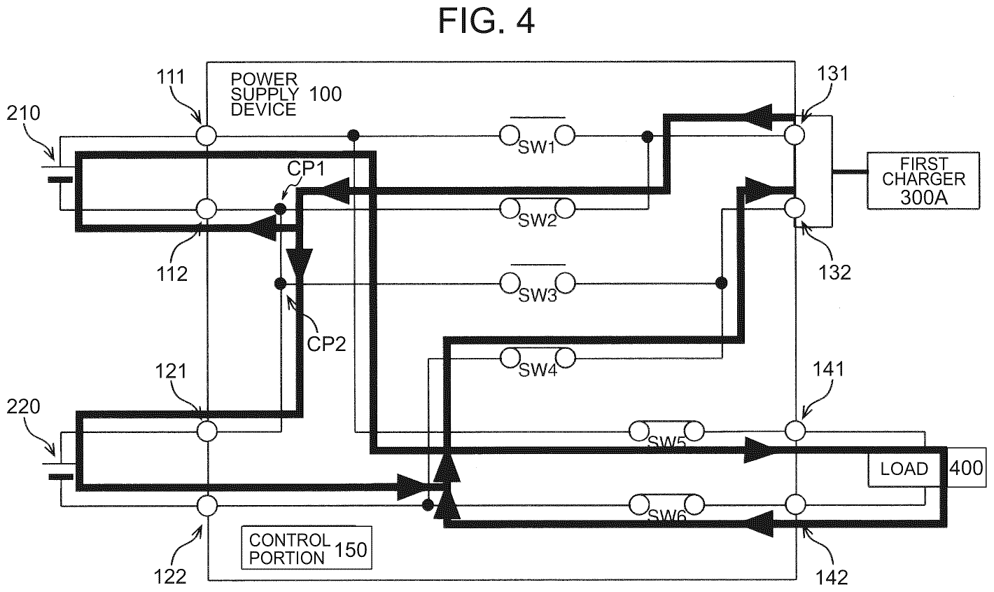

Also, according to the present embodiment, in a state (second state) in which the second switch SW2 and the fourth switch SW4 are closed while the first switch SW1 and the third switch SW3 are open, as shown in FIG. 4, the cathode of the second battery 220 is connected to the cathode-side input terminal 131 and the anode of the second battery 220 is connected to the anode-side input terminal 132. Accordingly, as shown in FIG. 4, in the second state, in a case in which a charger 300 is connected to the cathode-side input terminal 131 and the anode-side input terminal 132, it is possible to charge the second battery 220 by this charger 300.

Then, according to the present embodiment, when the first charger 300A (for example, the quick charger) is connected to the cathode-side input terminal 131 and the anode-side input terminal 132, the second switch SW2 and the fourth switch SW4 are closed while the first switch SW1 and the third switch SW3 are open such that the first switch SW1 to the fourth switch SW4 are put into the second state to charge the second battery 220. In this manner, according to the present embodiment, it is possible to charge the second battery 220 by the electricity at the second voltage, that is, by the electricity at the voltage corresponding to the first voltage as the drive voltage of the second battery 220.

The cathode-side output terminal 141 and the anode-side output terminal 142 are terminals for connecting the load 400. The operation voltage range of the load 400 is a range including the third voltage and a voltage twice the first voltage.

According to the present embodiment, the cathode-side output terminal 141 is connected to a line connecting the first switch SW1 and the first cathode-side battery terminal 111, and the anode-side output terminal 142 is connected to a line connecting the anode-side input terminal 132 and the second anode-side battery terminal 122.

Therefore, according to the present embodiment, regarding the cathode-side output terminal 141 and the anode-side output terminal 142, regardless of whether the first switch SW1 to the fourth switch SW4 are in the open state or the closed state, the voltage applied to the first battery 210 and the second battery 220 that are connected in series is applied to the load 400. Accordingly, in the present embodiment, even the open state and the closed state of the first switch SW1 to the fourth switch SW4 are switched, the voltage applied to the load 400 does not change significantly. Therefore, according to the present application, it is possible to provide the power supply device corresponding to multiple chargers without interrupting the operation of the load.

In FIG. 2, the load 400 is connected between the cathode-side input terminal 131 and the anode-side input terminal 132 to be in parallel to the first battery 210 and the second battery 220 that are connected in series, and the electricity at the voltage applied to the first battery 210 and the second battery 220 connected in series is supplied to the load 400 from the second charger 300B.

In FIG. 3, the first charger 300A and the second battery 220 are connected in series between the cathode-side output terminal 141 and the anode-side output terminal 142, and the first charger 300 and the first battery 210 are connected in parallel between the cathode-side output terminal 141 and the cathode of the second battery 220. Therefore, in FIG. 3, the electricity at the voltage applied to the first battery 210 and the second battery 220 that are connected in series is supplied to the load 400 from the first charger 300A and the second battery 220 that are connected in series.

In FIG. 4, the first charger 300A and the first battery 210 are connected in series between the cathode-side output terminal 141 and the anode-side output terminal 142, and the first charger 300 and the second battery 220 are connected in parallel between the anode of the first battery 210 and the anode-side output terminal 142. Therefore, in FIG. 4, the electricity at the voltage applied to the first battery 210 and the second battery 220 that are connected in series is supplied to the load 400 from the first charger 300A and the first battery 210 that are connected in series.

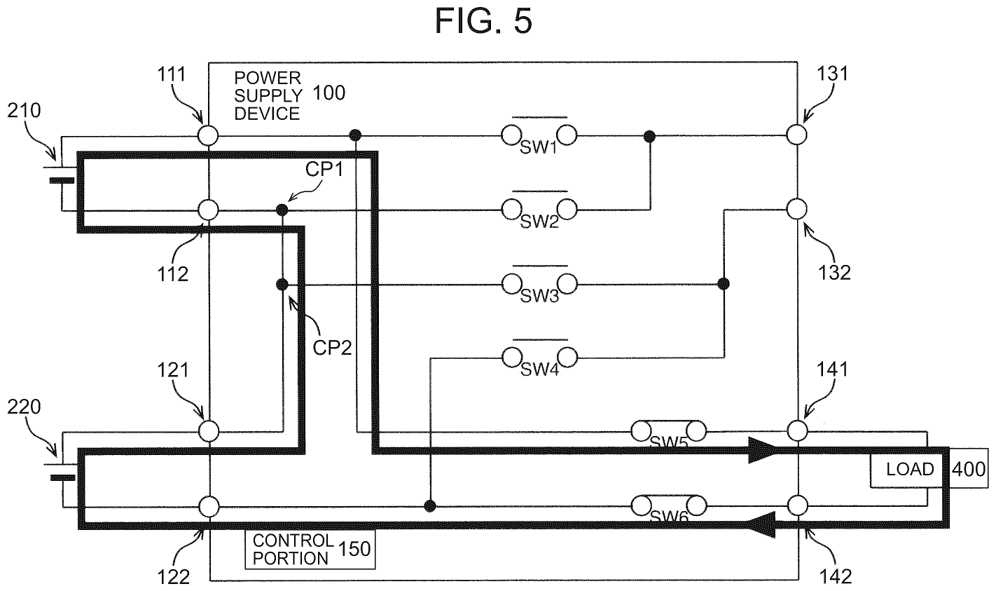

FIG. 5 shows an example of a state when the charger 300 is not connected to the cathode-side input terminal 131 and the anode-side input terminal 132 (for example, during the driving), regarding FIG. 5, all of the first switch SW1 to the fourth switch SW4 are open. At this time, the electricity at the voltage applied to the first battery 210 and the second battery 220 that are connected in series is supplied to the load 400 from the first battery 210 and the second battery 220 that are connected in series.

### <Control of First Switch SW1 to Fourth Switch SW4>

It is preferable that the power supply device 100 further includes a control portion 150 to control the first switch SW1, the second switch SW2, the third switch SW3, and the fourth switch SW4.

It is preferable for the control portion 150, for example, when the charger 300 is not connected to the cathode-side input terminal 131 and the anode-side input terminal 132, as shown in FIG. 5, to control all of the first switch SW1 to the fourth switch SW4 to be open. In this manner, it is possible to supply the electricity to the load 400 from the first battery 210 and the second battery 220 that are connected in series.

Also, for example, when the second charger 300B is connected to the cathode-side input terminal 131 and the anode-side input terminal 132, it is preferable for the control portion 150, as shown in FIG. 2, to control the first switch SW1 to the fourth switch SW4 into the state in which the first switch SW1 and the fourth switch SW4 are closed while the second switch SW2 and the third switch SW3 are open. In this manner, the load 400 is parallelly connected to the first battery 210 and the second battery 220 that are connected in series, between the cathode-side input terminal 131 and the anode-side input terminal 132, such that it is possible to charge the first battery 210 and the second battery 220 by the second charger 300B and supply the electricity at the voltage applied to the first battery 210 and the second battery 220 connected in series to the load 400 from the second charger 300B.

Also, for example, when the first charger 300A is connected to the cathode-side input terminal 131 and the anode-side input terminal 132, it is preferable for the control portion 150, as shown in FIG. 3, to control the first switch SW1 to the fourth switch SW4 into the state (first state) in which the first switch SW1 and the third switch SW3 are closed while the second switch SW2 and the fourth switch SW4 are open. In this manner, the first charger 300A and the second battery 220 are connected in series between the cathode-side output terminal 141 and the anode-side output terminal 142 while the first charger 300A and the first battery 210 are connected in parallel between the cathode-side output terminal 141 and the cathode of the second battery 220 such that it is possible to charge the first battery 210 by the first charger 300A and supply the electricity at the voltage applied to the first battery 210 and the second battery 220 that are connected in series to the load 400 from the first charger 300A and the second battery 220 that are connected in series.

Also, for example, when the first charger 300A is connected to the cathode-side input terminal 131 and the anode-side input terminal 132, it is preferable for the control portion 150, as shown in FIG. 4, to control the first switch SW1 to the fourth switch SW4 into the state (second state) in which the second switch SW2 and the fourth switch SW4 are closed while the first switch SW1 and the third switch SW3 are open. In this manner, the first charger 300A and the first battery 210 are connected in series between the cathode-side output terminal 141 and the anode-side output terminal 142 while the first charger 300A and the second battery 220 are connected in parallel between the anode of the first battery 210 and the anode-side output terminal 142 such that it is possible to charge the second battery 220 by the first charger 300A and supply the electricity at the voltage applied to the first battery 210 and the second battery 220 that are connected in series to the load 400 from the first charger 300A and the first battery 210 that are connected in series.

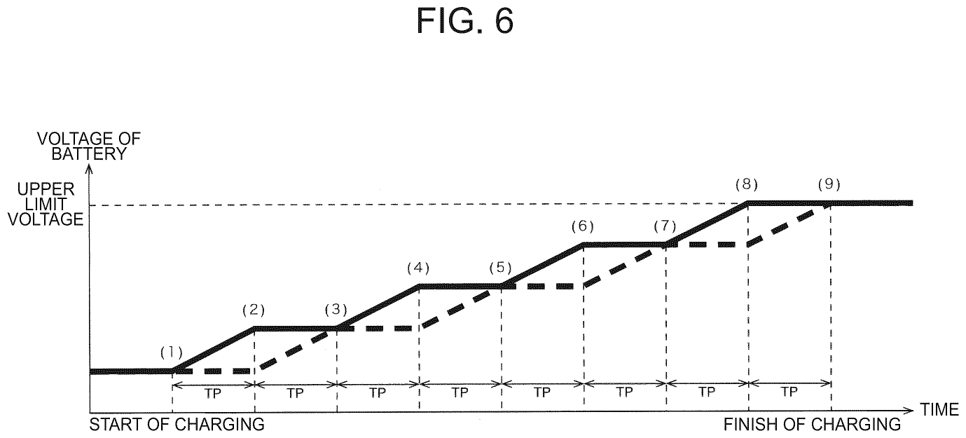

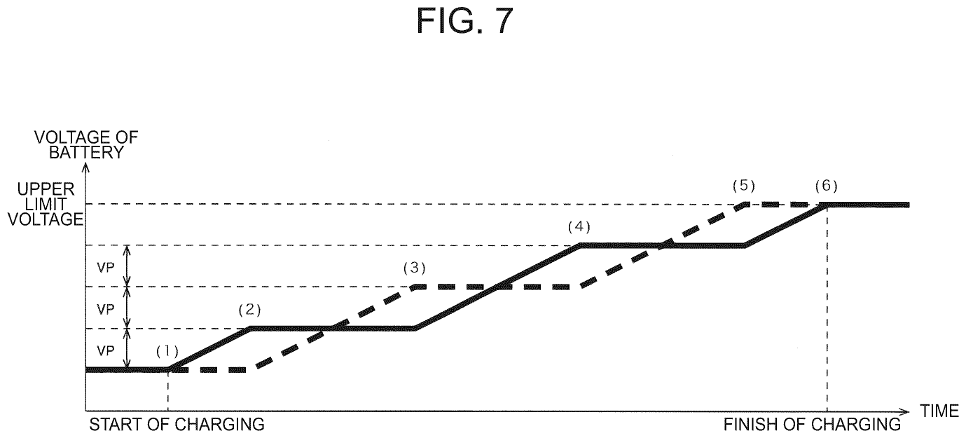

For example, when the first charger 300A is connected to the cathode-side input terminal 131 and the anode-side input terminal 132, as shown in FIG. 6, FIG. 7, it is preferable for the control portion 150 to control the first switch SW1 to the fourth switch SW4 to alternatively switch between the state (first state), as shown in FIG. 3, in which the first switch SW1 and the third switch SW3 are closed while the second switch SW2 and the fourth switch SW4 are open and the state (second state), as shown in FIG. 4, in which the second switch SW2 and the fourth switch SW4 are closed while the first switch SW1 and the third switch SW3 are open. In FIG. 6 and FIG. 7, the solid lines are showing the voltage of the first battery 210, and the dashed lines are showing the voltage of the second battery 220. In this manner, it is possible to charge the first battery 210 and the second battery 220 by the first charger 300A and supply the electricity at the voltage of the first battery 210 and the second battery 220 that are connected in series to the load 400 from the first charger 300A and the first battery 210 that are connected in series or the first charger 300A and the second battery 220 that are connected in series. At this time, the first battery 210 and the second battery 220 are charged alternatively. Accordingly, even if the charging by the first charger 300A terminates midway, it is possible to suppress variations in the charging amount in the first battery 210 and the second battery 220.

At this time, when the control portion 150 controls the first switch SW1 to the fourth switch SW4 to alternatively switch between the first state and the second state, as shown in FIG. 6, until the voltage of the first battery 210 and the voltage of the second battery 220 reach the upper charging limit of these batteries, it is preferable to switch the state of the first switch SW1 to the fourth switch SW4 every time when a predetermined period elapses.

In the example shown in FIG. 6, when the first charger 300A is connected to the cathode-side input terminal 131 and the anode-side input terminal 132, the control portion 150 is configured to: (1) at first, control the first switch SW1 to the fourth switch SW4 into the first state, (2) then, when a predetermined period TP elapses, switch the first switch SW1 to the fourth switch SW4 into the second state, (3) thereafter, when the predetermined period TP elapses, switch the first switch SW1 to the fourth switch SW4 into the first state, . . . (7) thereafter, when the predetermined period TP elapses, switch the first switch SW1 to the fourth switch SW4 into the first state, (8) thereafter, when the voltage of the first battery 210 reaches the upper charging limit of the first battery 210, switch the first switch SW1 to the fourth switch SW4 into the second state, (9) thereafter, when the voltage of the second battery 220 reaches the upper charging limit of the second battery 220, make all of the first switch SW1 to the fourth switch SW4 to be open, and ends the charging by the first charger 300A.

Also, when the control portion 150 control the first switch SW1 to the fourth switch SW4 to alternatively switch between the first state and the second state, until the voltage of the first battery 210 and the voltage of the second battery 220 reach the upper charging limit of these batteries, as shown in FIG. 7, it is preferable to switch the state of the first switch SW1 to the fourth switch SW4 every time when the voltage of the charging battery is higher than that of the other battery by a predetermined voltage value. In this manner, it is possible to suppress the number of times the state of the first switch SW1 to the fourth switch SW4 is switched.

In the example shown in FIG. 7, when the first charger 300A is connected to the cathode-side input terminal 131 and the anode-side input terminal 132, the control portion 150 is configured to: (1) at first, control the first switch SW1 to the fourth switch SW4 into the first state, (2) then, when the voltage of the first battery 210 is higher than the voltage of the second battery 220 by a predetermined voltage value VP, switch the first switch SW1 to the fourth switch SW4 into the second state, (3) thereafter, when the voltage of the second battery 220 is higher than the voltage of the first battery 210 by the predetermined voltage value VP, switch the first switch SW1 to the fourth switch SW4 into the first state, (4) thereafter, when the voltage of the first battery 210 is higher than the voltage of the second battery 220 by the predetermined voltage value VP, switch the first switch SW1 to the fourth switch SW4 into the second state, (5) thereafter, when the voltage of the second battery 220 reaches the upper charging limit of the second battery 220, switch the first switch SW1 to the fourth switch SW4 into the first state, (6) thereafter, when the voltage of the first battery 210 reaches the upper charging limit of the first battery 210, make all of the first switch SW1 to the fourth switch SW4 to be open, and ends the charging by the first charger 300A.

Also, as shown in FIG. 1, it is preferable to provide a fifth switch SW5 in the cathode-side output terminal 141 and a sixth switch SW6 in the anode-side output terminal 142. Then, it is preferable for the control portion 150 to control the fifth switch SW5 and the sixth switch SW6. In this manner, it is possible to cut off the supply of the power to the load 400.

Also, at this time, it is preferable for the control portion 150 to control the fifth switch SW5 and the sixth switch SW6 such that when the load 400 is connected to the cathode-side output terminal 141 and the anode-side output terminal 142, as shown in FIG. 2 to FIG. 5, the fifth switch SW5 and the sixth switch SW6 are closed, and when the load 400 is not connected to the cathode-side output terminal 141 and the anode-side output terminal 142, the fifth switch SW5 and the sixth switch SW6 are open. In this manner, when the load 400 is not connected to the cathode-side output terminal 141 and the anode-side output terminal 142, it is possible to separate the cathode-side output terminal 141 and the anode-side output terminal 142 from the first battery 210 and the second battery 220.

The present invention has been described above using preferred embodiments of the present invention. Although the present invention has been described herein with reference to specific examples, various modifications and changes can be made to these examples without departing from the spirit and scope of the invention as set forth in the claims.

### REFERENCE SIGNS LIST

100 power supply device
111 first cathode-side battery terminal
112 first anode-side battery terminal
121 second cathode-side battery terminal
122 second anode-side battery terminal
131 cathode-side input terminal
132 anode-side input terminal
141 cathode-side output terminal
142 anode-side output terminal
150 control portion
SW1 first switch
SW2 second switch
SW3 third switch
SW4 fourth switch
210 first battery
220 second battery
300 charger
300A first charger
300B second charger
400 load

What is claimed is:

1. A power supply device, comprising:
a first cathode-side battery terminal and a first anode-side battery terminal for connecting a battery;
a second cathode-side battery terminal and a second anode-side battery terminal for connecting a battery;
a cathode-side input terminal and an anode-side input terminal for connecting a charger;
a cathode-side output terminal and an anode-side output terminal for connecting a load;
a first switch;
a second switch;
a third switch; and
a fourth switch,
wherein the first anode-side battery terminal is connected to the second cathode-side battery terminal,
the first switch is connected between the first cathode-side battery terminal and the cathode-side input terminal,
the second switch is connected between a first connection point, which is between the first anode-side battery terminal and the second cathode-side battery terminal, and the cathode-side input terminal,
the third switch is connected between a second connection point, which is between the first anode-side battery terminal and the second cathode-side battery terminal, and the anode-side input terminal,
the fourth switch is connected between the second anode-side battery terminal and the anode-side input terminal,
the cathode-side output terminal is connected to a line connecting the first switch and the first cathode-side battery terminal, and
the anode-side output terminal is connected to a line connecting the anode-side input terminal and the second anode-side battery terminal.

2. The power supply device according to claim 1, further comprises a control portion to control the first switch, the second switch, the third switch, and the fourth switch,
wherein the control portion controls all of the first switch, the second switch, the third switch, and the fourth switch to be open if
a first battery with a first voltage as a drive voltage is connected to the first cathode-side battery terminal and the first anode-side battery terminal,
a second battery with the first voltage as a drive voltage is connected to the second cathode-side battery terminal and the second anode-side battery terminal,
no charger is connected to the cathode-side input terminal and the anode-side input terminal, and
a load with an operation voltage range including a voltage twice the first voltage is connected to the cathode-side output terminal and the anode-side output terminal.

3. The power supply device according to claim 2,
wherein the control portion controls the first switch, the second switch, the third switch, and the fourth switch into a first state in which the first switch and the third switch are closed while the second switch and the fourth switch are open if
the first battery is connected to the first cathode-side battery terminal and the first anode-side battery terminal,
the second battery is connected to the second cathode-side battery terminal and the second anode-side battery terminal,
a first charger supplying electricity at a second voltage as a voltage being equal to or higher than the first voltage and lower than twice the first voltage is connected, and
the load is connected to the cathode-side input terminal and the anode-side input terminal.

4. The power supply device according to claim 2,
wherein the control portion controls the first switch, the second switch, the third switch, and the fourth switch into a second state in which the second switch and the fourth switch are closed while the first switch and the third switch are open if
the first battery is connected to the first cathode-side battery terminal and the first anode-side battery terminal,
the second battery is connected to the second cathode-side battery terminal and the second anode-side battery terminal,
a first charger supplying electricity at a second voltage as a voltage being equal to or higher than the first voltage and lower than twice the first voltage is connected, and
the load is connected to the cathode-side input terminal and the anode-side input terminal.

5. The power supply device according to claim 2,
wherein the control portion controls the first switch, the second switch, the third switch, and the fourth switch to alternatively switch between a first state in which the first switch and the third switch are closed while the second switch and the fourth switch are open and a second state in which the second switch and the fourth switch are closed while the first switch and the third switch are open if
the first battery is connected to the first cathode-side battery terminal and the first anode-side battery terminal,
the second battery is connected to the second cathode-side battery terminal and the second anode-side battery terminal,
a first charger supplying electricity at a second voltage as a voltage being equal to or higher than the first voltage and lower than twice the first voltage is connected, and
the load is connected to the cathode-side input terminal and the anode-side input terminal.

6. The power supply device according to claim 5, wherein when the control portion controls the first switch, the second switch, the third switch, and the fourth switch to alternative switch between the first state and the second state, the control portion switches the state of the first switch, the second switch, the third switch, and the fourth switch every time when a predetermined period elapses.

7. The power supply device according to claim 5, wherein when the control portion controls the first switch, the second switch, the third switch, and the fourth switch to alternative switch between the first state and the second state, the control portion switches the state of the first switch, the second switch, the third switch, and the fourth switch every time when a voltage of a battery during charging becomes higher than the voltage of the other battery by a predetermined voltage value.

8. The power supply device according to claim 2,
wherein the control portion controls the first switch, the second switch, the third switch, and the fourth switch into a state in which the first switch and the fourth switch are closed while the second switch and the third switch are open if
the first battery is connected to the first cathode-side battery terminal and the first anode-side battery terminal,
the second battery is connected to the second cathode-side battery terminal and the second anode-side battery terminal,
a second charger supplying electricity at a third voltage as a voltage being equal to or higher than twice the first voltage, and
a load whose operation voltage range includes the third voltage and a voltage twice the first voltage is connected to the cathode-side input terminal and the anode-side input terminal.
